(19) United States
(12) Patent Application Publication
(10) Pub. No.: US 2025/0117346 A1
(43) Pub. Date: Apr. 10, 2025

(54) DYNAMIC AFFINITY ROUTING OF INTERRUPTS IN A MULTIPROCESSOR SYSTEM ON A CHIP (SOC)

(71) Applicant: QUALCOMM Incorporated, San Diego, CA (US)

(72) Inventors: Mohd SALMAN, Kiratpur (IN); Utkarsh VINAYAK, Patna (IN); Sharath Kumar NAGILLA, Hyderabad (IN); Hithesh Hassan LEPAKSHA, Hyderabad (IN)

(21) Appl. No.: 18/482,793

(22) Filed: Oct. 6, 2023

(51) Int. Cl. G06F 13/26

(52) U.S. Cl. CPC G06F 13/26

(57) ABSTRACT

Aspects of the disclosure are directed to interrupt handling. In accordance with one aspect, disclosed includes a first processing engine; a second processing engine; and a timeout monitoring block coupled to the first processing engine and the second processing engine, wherein the timeout monitoring block is configured to reaffinitize an interrupt affined to the first processing engine to the second processing engine. Also disclosed for interrupt handling includes placing a first interrupt into a pending state; initiating a handling of a second interrupt; initiating a programmed timeout value; triggering a timeout state of the first interrupt when an interrupt timer reaches the programmed timeout value; and entering a reaffinitization state of the first interrupt after the timeout state is triggered.

### TECHNICAL FIELD

This disclosure relates generally to the field of information processing systems, and, in particular, to interrupt handling.

### BACKGROUND

Many information processing systems include multiple processing engines, processors or processing cores for a variety of user applications. An information processing system may include a central processing unit (CPU), a graphics processing unit (GPU), a digital signal processor (DSP), an image signal processor (ISP), a neural processing unit (NPU), etc., along with input/output interfaces, a hierarchy of memory units and associated interconnection databuses. For certain applications, tasks may be assigned to the multiple processing engines for parallel execution. Task execution is normally dictated by a programmed set of instructions (i.e., programmed tasks determined by software). Certain tasks may be initiated asynchronously using interrupts (i.e., interrupt tasks determined in real time), which are handled using an interrupt handler. Since interrupts may be affined (i.e., assigned) to a particular processing engine or core, performance bottlenecks may occur due to prioritization in the interrupt handler. Thus, information processing system performance may be modified with alternative interrupt handling routines.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides interrupt handling. Accordingly, an apparatus for implementing interrupt handling including: a first processing engine; a second processing engine; and a timeout monitoring block coupled to the first processing engine and the second processing engine, wherein the timeout monitoring block is configured to reaffinitize an interrupt affined to the first processing engine to the second processing engine.

In one example, the apparatus further includes an interrupt timer configured to trigger a transition from a pending state to a timeout state of the interrupt. In one example, the interrupt timer is a component of the timeout monitoring block. In one example, the apparatus further includes a distributor configured to control and to manage the first processing engine and the second processing engine. In one example, the timeout monitoring block is coupled to the distributor via a data interface and a control interface.

In one example, the timeout monitoring block resides within the distributor. In one example, the apparatus further includes a first peripheral module coupled to the first processing engine, wherein the first peripheral module is configured to receive a first private peripheral interrupt (PPI) as a first type of interrupt trigger and a first local peripheral interrupt (LPI) as a second type of interrupt trigger.

In one example, the apparatus further includes a second peripheral module coupled to the second processing engine, wherein the second peripheral module is configured to receive a second private peripheral interrupt (PPI) as a third type of interrupt trigger and a second local peripheral interrupt (LPI) as a fourth type of interrupt trigger.

In one example, the apparatus further includes a first CPU interface configured to send a first software generated interrupt (SGI) generated by the first processing engine to the distributor. In one example, the first software generated interrupt (SGI) is subsequently routed by the distributor within an information processing system. In one example, the apparatus further includes a second CPU interface configured to send a second software generated interrupt (SGI) generated by the second processing engine to the distributor. In one example, the second software generated interrupt (SGI) is subsequently routed by the distributor within an information processing system.

Another aspect of the disclosure provides a method for implementing interrupt handling including: placing a first interrupt into a pending state; initiating a handling of a second interrupt; initiating a programmed timeout value; triggering a timeout state of the first interrupt when an interrupt timer reaches the programmed timeout value; and entering a reaffinitization state of the first interrupt after the timeout state is triggered.

In one example, the first interrupt includes a first priority tag value, and the second interrupt includes a second priority tag value. In one example, the second priority tag value is higher than the first priority tag value. In one example, the method further includes initializing the interrupt timer to the programmed timeout value. In one example, the initializing the interrupt timer includes enabling a timeout mechanism.

In one example, the method further includes reaffinitizing the first interrupt from a first interrupt handler to a second interrupt handler. In one example, the method further includes receiving the first interrupt asynchronously relative to a plurality of programmed tasks. In one example, the method further includes receiving the first interrupt spontaneously relative to a plurality of programmed tasks. In one example, the method further includes initiating a handling of the first interrupt with the first interrupt handler.

In one example, the method further includes receiving the second interrupt asynchronously relative to the plurality of programmed tasks. In one example, the method further includes receiving the second interrupt spontaneously relative to the plurality of programmed tasks. In one example, the method further includes completing the handling of the first interrupt with the second interrupt handler. In one example, the method further includes executing the plurality of programmed tasks.

Another aspect of the disclosure provides an apparatus for implementing interrupt handling, the apparatus including: means for placing a first interrupt into a pending state; means for initiating a handling of a second interrupt; means for initiating a programmed timeout value; means for triggering a timeout state of the first interrupt when an interrupt timer reaches a programmed timeout value; and means for entering a reaffinitization state of the first interrupt after the timeout state is triggered.

In one example, the apparatus further includes means for initializing an interrupt timer to the programmed timeout value; means for reaffinitizing the first interrupt from a first interrupt handler to a second interrupt handler; means for receiving the first interrupt asynchronously or spontaneously relative to a plurality of programmed tasks; means for initiating a handling of the first interrupt with the first interrupt handler; and means for receiving the second interrupt asynchronously or spontaneously relative to the plurality of programmed tasks.

Another aspect of the disclosure provides a non-transitory computer-readable medium storing computer executable code, operable on a device including at least one processor and at least one memory coupled to the at least one processor, wherein the at least one processor is configured to implement interrupt handling, the computer executable code including: instructions for causing a computer to place a first interrupt into a pending state; instructions for causing the computer to initiate a handling of a second interrupt; instructions for causing the computer to initiate a programmed timeout value; instructions for causing the computer to trigger a timeout state of the first interrupt when an interrupt timer reaches a programmed timeout value; and instructions for causing the computer to enter a reaffinitization state of the first interrupt after the timeout state is triggered.

In one example, the non-transitory computer-readable medium further includes instructions for causing the computer to perform the following: initialize an interrupt timer to the programmed timeout value; reaffinitize the first interrupt from a first interrupt handler to a second interrupt handler; receive the first interrupt asynchronously or spontaneously relative to a plurality of programmed tasks; initiate a handling of the first interrupt with the first interrupt handler; and receive the second interrupt asynchronously or spontaneously relative to the plurality of programmed tasks.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example scenario interrupt process flow with prioritization of interrupts affined to a single processing engine of an information processing system.

FIG. 3 illustrates an example information processing system with reaffinitization of interrupts.

FIG. 4 illustrates an example scenario interrupt process flow with reaffinitization of interrupts from a first processing engine to a second processing engine.

FIG. 5 illustrates an example flow diagram for interrupt reaffinitization with a timeout mechanism.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), requires multiple levels of coordination or synchronization. In one example, a slice includes a processing engine (i.e., a subset of the computing system) as well as associated memory units and other peripheral units. In one example, execution of an application may be decomposed into a plurality of work tasks which are executed by multiple slices or multiple processing engines.

In one example, the associated memory units of the information processing system may form a memory hierarchy with a local memory unit or an internal cache memory unit dedicated to each slice, a global memory unit shared among all slices and other memory units with various degrees of shared access. For example, a first level cache memory or L1 cache memory may be a memory unit dedicated to a single processing engine and may be optimized with a faster memory access time at the expense of storage space. For example, a second level cache memory or L2 cache memory may be a memory unit which is shared among more than one processing engine and may be optimized to provide a larger storage space at the expense of memory access time. In one example, each slice or each processing engine includes a dedicated internal cache memory.

In one example, the memory hierarchy may be organized as a cascade of cache memory units with the first level cache memory, the second level cache memory and other memory units with increasing storage space and slower memory access time going up the memory hierarchy. In one example, other cache memory units in the memory hierarchy may be introduced which are intermediate between existing memory units. For example, an L1.5 cache memory, which is intermediate between the L1 cache memory and the L2 cache memory, may be introduced in the memory hierarchy of the information processing system.

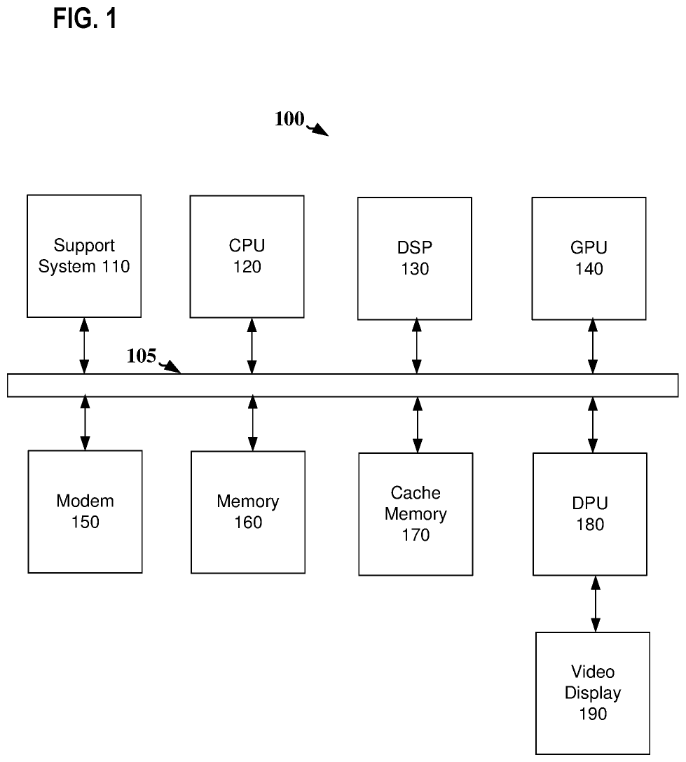

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

One technique used in an information processing system is parallel processing, that is, processing of a plurality of threads in parallel among a plurality of processing engines. A thread is a group of logically connected processing tasks. Parallel processing of the plurality of threads may involve both internal (i.e., dedicated) memory and shared memory. In one example, execution of the plurality of threads is initiated by the plurality of processing engines and includes read operations into shared memory and write operations into shared memory. For example, read operations retrieve data from shared memory locations and write operations store data into shared memory. In one example, management and control of the plurality of processing engines are performed in software by an operating system.

In one example, there are a plurality of task types in the information processing system. For example, programmed tasks may be determined by software. For example, programmed tasks may be managed by an operating system a priori to the time of task execution since software may prescribe the programmed task sequencing. In one example, interrupt tasks may not be determined by software since they may be initiated in real time (i.e., at the time of task execution).

In one example, an interrupt is a signaling mechanism used in an information processing system to allow interrupt tasks to be processed asynchronously or spontaneously by a processing engine or core separately from programmed tasks. In one example, an interrupt agent (i.e., an entity within the information processing system which initiates an interrupt task) may send an interrupt to the operating system.

In one example, an interrupt handler, which may be part of an operating system for the information processing system, manages interrupts as they occur. In one example, interrupt management includes interrupt assignment or affinity. That is, for example, a particular interrupt may be assigned for processing by one processing engine out of a plurality of processing engines. In one example, the interrupt handler includes an interrupt service routine (ISR) for managing and processing interrupts.

In one example, interrupt management includes prioritization, that is, assignment of priority tags to interrupts to regulate an ordering of interrupt task processing. For example, the priority tag may be a priority tag value (e.g., integer) which indicates a relative priority order. For example, a first priority tag value may be 1 to denote a highest priority, a second priority tag value may be 2 to denote a second highest priority, a third priority tag value may be 3 to denote a third highest priority, etc. For example, if a first interrupt with a first priority tag and a second interrupt with a second priority tag (which are both assigned for processing to a particular processing engine) are active simultaneously, then ordering of execution of interrupt task processing for the first interrupt and the second interrupt is regulated by determining which priority tag (i.e., first priority tag or second priority tag) has the higher priority tag value (e.g., which interrupt has higher priority). In one example, a higher priority tag value is a lower numeric value. That is, a first interrupt with a priority tag value of 1 (i.e., one) has a higher priority than a second interrupt with a priority tag value of 2 (i.e., two).

In one example, when a first interrupt is affined to a particular processing engine and is currently being serviced by the interrupt handler, and if a second interrupt, which is affined to the same particular processing engine, is received by the interrupt handler, the second interrupt is placed into a pending state if its priority tag value has the same or lower value than the priority tag value of the first interrupt (i.e., a higher priority interrupt). For example, a lower priority interrupt (i.e., the second interrupt) remains in the pending state until all other interrupts affined to the same processing engine with a higher priority have been serviced. In one example, placement into the pending state results in an indefinite delay or interrupt latency in servicing of the second interrupt. That is, no servicing of an interrupt is performed during its pending state. In one example, affinitization refers to a process of affining or assigning a task or an interrupt to a processing engine.

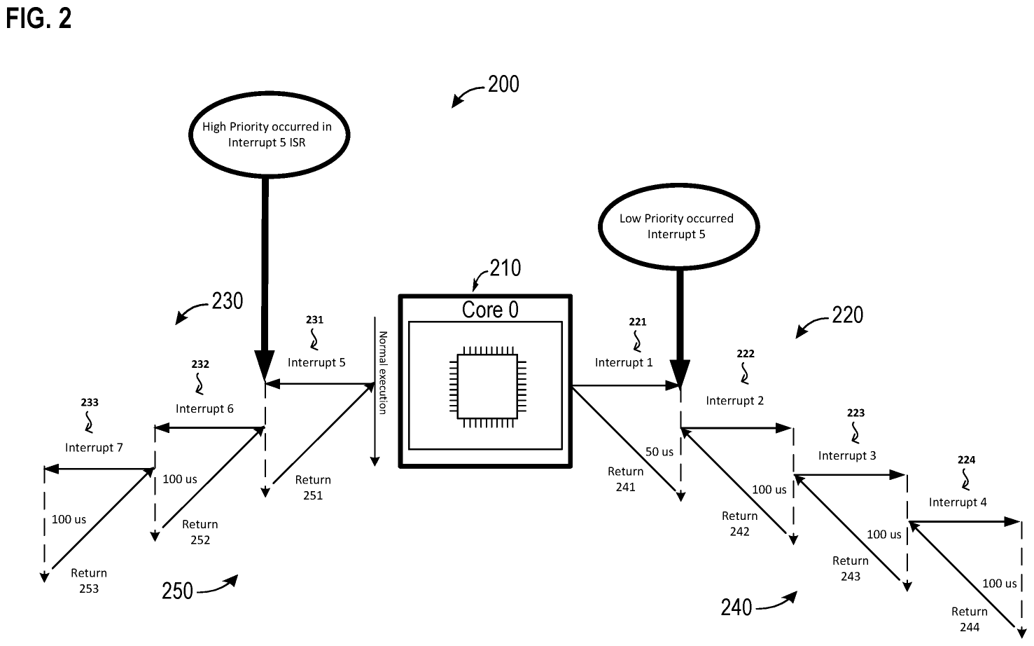

FIG. 2 illustrates an example scenario interrupt process flow 200 with prioritization of interrupts affined to a single processing engine of an information processing system. In one example, the single processing engine 210 is executing a plurality of programmed tasks when a first interrupt string 220 is received. In one example, a first interrupt (e.g., Interrupt 1) 221 of the first interrupt string 220 is received. An interrupt handler of the single processing engine 210 commences handling of the first interrupt (e.g., Interrupt 1) 221. In one example, a fifth interrupt (e.g., Interrupt 5) 231 is received. For example, the fifth interrupt 231 has a lower priority tag value than the first interrupt 221, so the fifth interrupt 231 is placed into a pending state. Next, a second interrupt (e.g., Interrupt 2) 222 of the first interrupt string 220 is received. In one example, the second interrupt 222 has a higher priority tag value than the first interrupt 221. The interrupt handler then services the second interrupt 222 and places the first interrupt 221 into a pending state.

Next, a third interrupt (e.g., Interrupt 3) 223 of the first interrupt string 220 is received. In one example, the third interrupt 223 has a higher priority tag value than the second interrupt 222. The interrupt handler then services the third interrupt 223 and places the second interrupt 222 into a pending state. Next, a fourth interrupt (e.g., Interrupt 4) 224 of the first interrupt string 220 is received. In one example, the fourth interrupt 224 has a higher priority tag value than the third interrupt 223. The interrupt handler then services the fourth interrupt 224 and places the third interrupt 223 into a pending state. In one example, the servicing of the first interrupt 221 is delayed until at least the completion of servicing of the higher priority interrupts; that is, servicing of the fourth interrupt 224, the third interrupt 223 and the second interrupt 222, which in the examples herein, have higher priority than the first interrupt 221.

In one example, upon completion of the servicing of the fourth interrupt 224, a fourth return 244 is initiated to restart the third interrupt 223. In one example, upon completion of the servicing of the third interrupt 223, a third return 243 is initiated to restart the second interrupt 222. In one example, upon completion of the servicing of the second interrupt 222, a second return 242 is initiated to restart the first interrupt 221. In one example, upon completion of the servicing of the first interrupt 221, a first return 241 occurs and the fifth interrupt 231 starts getting processed. In one example, a sixth interrupt 232 is received which has a higher priority tag value than the fifth interrupt 231. In one example, servicing of the sixth interrupt 232 commences, ahead of the fifth interrupt 231.

In one example, a seventh interrupt (e.g., Interrupt 7) 233 of the second interrupt string 230 is received. In one example, the seventh interrupt 233 has a higher priority tag value than the sixth interrupt 232. The interrupt handler then services the seventh interrupt 233 and places the sixth interrupt 232 into a pending state. In one example, the servicing of the fifth interrupt 231 is delayed until at least the completion of servicing of the higher priority interrupts; that is, servicing of the seventh interrupt 233 and the sixth interrupt 232 which in the examples herein, have higher priority than the fifth interrupt 231.

In one example, upon completion of the servicing of the seventh interrupt 233, a seventh return 253 is initiated to restart the sixth interrupt 232. In one example, upon completion of the servicing of the sixth interrupt 232, a sixth return 252 is initiated to restart the fifth interrupt 231. In one example, upon completion of the servicing of the fifth interrupt 231, a fifth return 251 is initiated to return to execution of processing tasks by the first processing engine 210.

In one example, as illustrated in FIG. 2, since the fifth interrupt 231 is lower in priority to the interrupts in the first interrupt string 220 and to the interrupts in the second interrupt string 230, all affined to the first processing engine 210, the servicing of the fifth interrupt 231 by the interrupt handler has a large delay, for example, 650 μs. That is, in one example, interrupt handling of interrupts affined to one processing engine may encounter excessive service latency.

In one example, interrupt handling latency with prioritization of interrupts affined to a first processing engine may be minimized by introducing a timeout mechanism and a reaffinitization state. The timeout mechanism during a pending state may employ an interrupt timer with a programmed timeout value. For example, the timeout mechanism may be activated for a pending interrupt where the interrupt timer is enabled (i.e., initiated with time value of zero) when a particular interrupt enters the pending state. In one example, a timeout state of the first processing engine is triggered when the interrupt timer time value reaches the programmed timeout value and the pending interrupt does not transition to an execution state.

In one example, the reaffinitization state is entered from the pending state when the timeout state is reached and the affinity (i.e., assignment) of the pending interrupt is changed from the first processing engine to a second processing engine. For example, the second processing engine may be idle (i.e., not currently serving any interrupts) when the timeout state of the first processing engine is reached. That is, the interrupt handling of the pending interrupt is transferred from the first processing engine to the second processing engine when the reaffinitization state is entered.

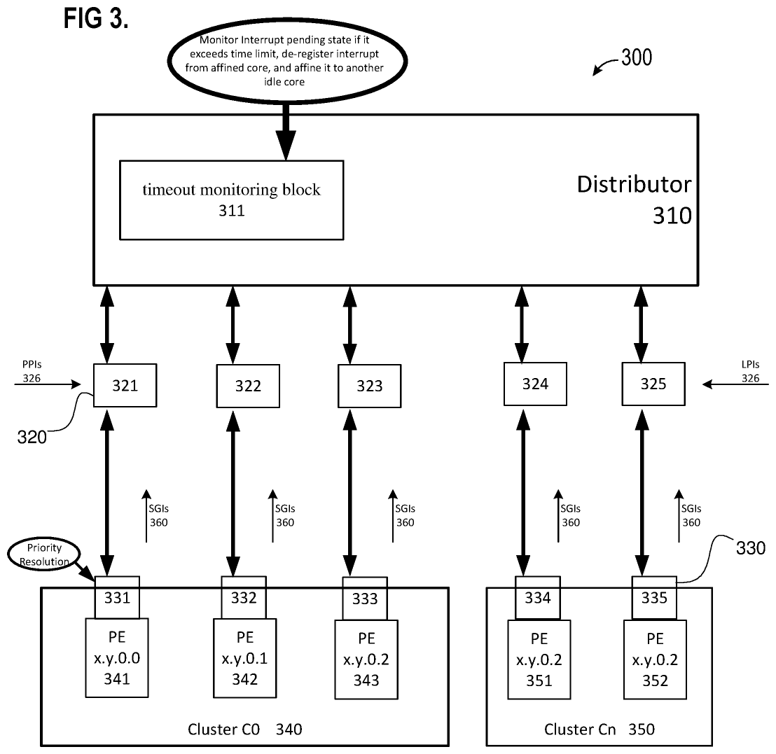

FIG. 3 illustrates an example information processing system 300 with reaffinitization of interrupts. In one example, the reaffinization is from a first processing engine to a second processing engine. In one example, the information processing system 300 includes a distributor 310 which serves as a central controller and manager of a plurality of processing engines in the information processing system 300. In one example, the distributor 310 includes a timeout monitoring block 311 which manages a state of a pending interrupt by monitoring a pending state and a timeout state. For example, if the timeout state of the pending interrupt is reached, the timeout monitoring block 311 deregisters the pending interrupt from the first processing engine and reaffines (i.e., reassigns) the pending interrupt to the second processing engine. In one example, the timeout monitoring block 311 includes an interrupt timer to trigger a transition from a pending state to a timeout state of the interrupt.

In one example, the distributor 310 receives shared peripheral interrupts (SPI) 312 from external elements as a first type of interrupt trigger. In one example, the timeout monitoring block 311 performs dynamic affinity routing. That is, it performs reaffinization of interrupts from one processing engine to another. In one example, the timeout monitoring block 311 is coupled to the distributor 310 via a data interface (not shown) and a control interface (not shown). In one example, the data interface transports data plane information between the distributor 310 and the timeout monitoring block 311. In one example, the control interface transports control plane information between the distributor 310 and the timeout monitoring block 311. For example, data plane information may relate to functions associated with task execution. For example, control plane information may relate to functions associated with task configuration and control.

In one example, the distributor 310 is connected to a plurality of peripheral modules 320, including a first peripheral module 321, a second peripheral module 322, a third peripheral module 323, a fourth peripheral module 324, a fifth peripheral module 325, etc. In one example, the plurality of peripheral modules 320 receives private peripheral interrupts (PPI) 326 as a second type of interrupt triggers and local peripheral interrupts (LPI) 327 as a third type of interrupt triggers. In one example, the peripheral modules 320 is a redistributor for reaffinization of interrupts.

In one example, the plurality of peripheral modules 320 are connected to a plurality of processing clusters including a first cluster 340 and a second cluster 350. In one example, the first cluster 340 includes a first processing engine 341, a second processing engine 342 and a third processing engine 343. In one example, the second cluster 350 includes a fourth processing engine 351 and fifth processing engine 352. In one example, the plurality of processing clusters includes a plurality of central processing unit (CPU) interfaces 330 including a first CPU interface 331, a second CPU interface 332, a third CPU interface 333, a fourth CPU interface 334 and a fifth CPU interface 335. In one example, the plurality of CPU interfaces 330 sends a plurality of software generated interrupts (SGI) 360, generated by the plurality of processing clusters, to the distributor 310 for subsequent routing within the information processing system. In one example, in FIG. 3, a blue line indicates an interrupt flow from distributor to processor core. In one example, in FIG. 3, a solid blue line represents an interrupt which was first assigned to a first processing engine and a dashed blue line represents the interrupt which is re-assigned to a second processing engine.

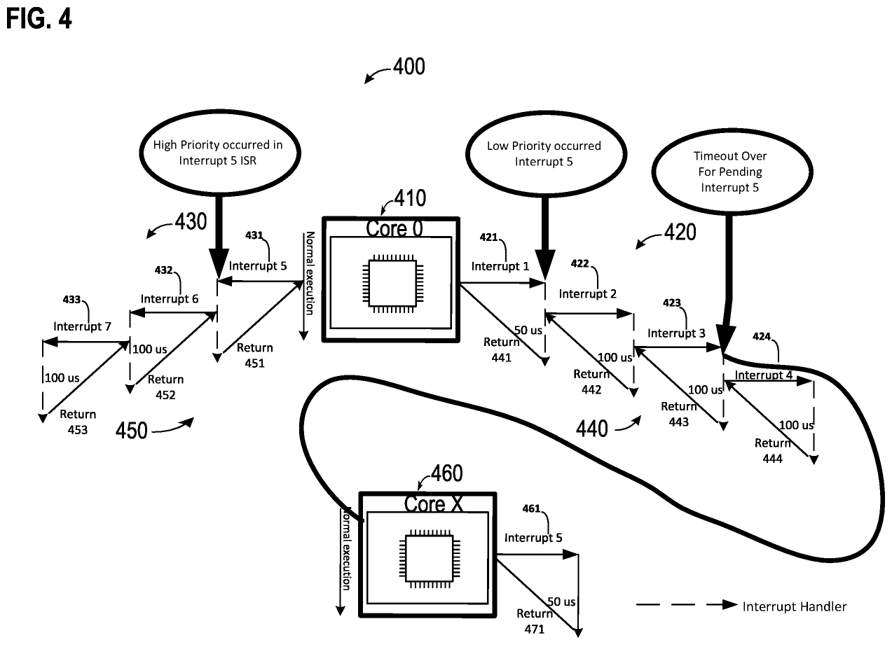

FIG. 4 illustrates an example scenario interrupt process flow 400 with reaffinitization of interrupts from a first processing engine 410 to a second processing engine 460. In one example, the first processing engine 410 is executing a plurality of programmed tasks when a first interrupt string 420 is received. In one example, a first interrupt (e.g., Interrupt 1) 421 of the first interrupt string 420 is received. A first interrupt handler of the first processing engine 410 commences handling of the first interrupt (e.g., Interrupt 1) 421 and a second interrupt (e.g., Interrupt 2) 422 of the first interrupt string 420 is received. In one example, a fifth interrupt 431 is received prior to the second interrupt 422. In one example, the fifth interrupt 431 is placed into a pending state since it has a lower priority tag value than the first interrupt 421. In one example, the second interrupt 422 has a higher priority tag value than the first interrupt 421. The first interrupt handler then services the second interrupt 422 and places the first interrupt 421 into a pending state.

Next, a third interrupt (e.g., Interrupt 3) 423 of the first interrupt string 420 is received. In one example, the third interrupt 423 has a higher priority tag value than the second interrupt 422. The first interrupt handler then services the third interrupt 423 and places the second interrupt 422 into a pending state. Next, a fourth interrupt (e.g., Interrupt 4) 424 of the first interrupt string 420 is received. In one example, the fourth interrupt 424 has a higher priority tag value than the third interrupt 423. The interrupt handler then services the fourth interrupt 424 and places the third interrupt 423 into a pending state. In one example, the servicing of the first interrupt 421 is delayed until at least the completion of servicing of the higher priority interrupts; that is, servicing of the fourth interrupt 424, the third interrupt 423 and the second interrupt 422, which in the examples herein, have higher priority than the first interrupt 421.

In one example, upon completion of the servicing of the fourth interrupt 424, a fourth return 444 is initiated to restart the third interrupt 423. In one example, upon completion of the servicing of the third interrupt 423, a third return 443 is initiated to restart the second interrupt 422. In one example, upon completion of the servicing of the second interrupt 422, a second return 442 is initiated to restart the first interrupt 421. In one example, upon completion of the servicing of the first interrupt 421, servicing of the fifth interrupt 431 commences. In one example, a sixth interrupt 432 is received. In one example, the sixth interrupt 432 has a higher priority tag value than the fifth interrupt 431 so the sixth interrupt 432 is serviced ahead of the fifth interrupt 421.

In one example, the first processing engine 410 is executing a plurality of programmed tasks when a second interrupt string 430 is received. In one example, the first interrupt handler of the first processing engine 410 commences handling of the fifth interrupt (e.g., Interrupt 5) 431 and a sixth interrupt (e.g., Interrupt 6) 432 of the second interrupt string 430 is received. In one example, the sixth interrupt 432 has a higher priority tag value than the fifth interrupt 431. The first interrupt handler then services the sixth interrupt 432 and places the fifth interrupt 431 into a pending state.

Next, a seventh interrupt (e.g., Interrupt 7) 433 of the second interrupt string 430 is received. In one example, the seventh interrupt 433 has a higher priority tag value than the sixth interrupt 432. The first interrupt handler then services the seventh interrupt 433 and places the sixth interrupt 432 into a pending state. In one example, the servicing of the fifth interrupt 431 is delayed until at least the completion of servicing of the higher priority interrupts; that is, servicing of the seventh interrupt 433 and the sixth interrupt 432, which in the examples herein, have higher priority than the fifth interrupt 431.

In one example, upon completion of the servicing of the seventh interrupt 433, a seventh return 453 is initiated to restart the sixth interrupt 432. In one example, upon completion of the servicing of the sixth interrupt 432, a sixth return 452 is initiated to restart the fifth interrupt 431. In one example, upon completion of the servicing of the fifth interrupt 431, a fifth return 451 is initiated to return to execution of processing tasks by the first processing engine 410.

In one example, a timeout monitoring block within the information processing system may be initiated to manage a state of a pending interrupt by monitoring a pending state, a timeout state and a reaffinitization state. For example, the pending interrupt transitions from the pending state to the timeout state when an interrupt timer reaches a programmed timeout value, that is the interrupt timer triggers a transition from a pending state to a timeout state of the pending interrupt.

For example, if the timeout state of the pending interrupt is reached, the timeout monitoring block deregisters the pending interrupt from the first processing engine 410 and reaffines (i.e., reassigns) the pending interrupt to the second processing engine 460 and transitions the pending interrupt to the reaffinitization state. In one example, the timeout monitoring block may be part of the first processing engine 410.

In one example, execution of the plurality of programmed tasks has commenced when the fifth interrupt 431 with a fifth priority tag value of the second interrupt string 430 is received. In one example, the first interrupt handler of the first processing engine 410 initiates handling of the fifth interrupt 431. Next, in one example, the sixth interrupt 432 with a sixth priority tag value of the second interrupt string 430 is received. In one example, the sixth interrupt 432 has a higher priority tag value than the fifth interrupt 431. That is, the sixth priority tag value is higher than the fifth priority tag value. The first interrupt handler then services the sixth interrupt 432 and places the fifth interrupt 431 into a pending state.

In one example, upon detection of the transition of the fifth interrupt 431 into the pending state, that is the fifth interrupt 431 becomes a pending interrupt, the timeout monitoring block initiates a timeout mechanism with a programmed timeout value using an interrupt timer. For example, the timeout mechanism may be activated for the pending interrupt where the interrupt timer is enabled (i.e., initiated with time value of zero) when the fifth interrupt 431 enters the pending state. In one example, a timeout state of the fifth interrupt 431 is triggered when the interrupt timer reaches the programmed timeout value and the pending interrupt does not transition to an execution state.

In one example, the reaffinitization state is entered from the timeout state when the timeout state is reached and the affinity (i.e., assignment) of the pending interrupt (e.g., fifth interrupt 431) is changed from the first processing engine 410 to a second processing engine 460. For example, the second processing engine 460 with a second interrupt handler may be idle (i.e., not currently serving any interrupts) when the timeout state of the fifth interrupt 431 is reached. That is, the interrupt handling of the pending interrupt (e.g., fifth interrupt 431) is transferred from the first interrupt handler of the first processing engine 410 to the second interrupt handler of the second processing engine 460 when the reaffinitization state is entered. Upon entering the reaffinitization state, the second processing engine 460 may commence an execution state for the pending interrupt (e.g., fifth interrupt 431) to complete interrupt handling of the pending interrupt (e.g., fifth interrupt 431) using the second interrupt handler. In one example, the service latency for the pending interrupt (e.g., fifth interrupt 431) is reduced with the incorporation of the timeout mechanism.

In one example, as illustrated in FIG. 4, the service latency for the fifth interrupt 431 is reduced from 650 μs without the timeout mechanism to 320 μs with the timeout mechanism, assuming a timeout value of 220 μs. As a result, the timeout mechanism reduces interrupt handling latency.

In one example, incorporation of interrupt reaffinitization with a timeout mechanism allows finer control of interrupt execution time. For example, interrupts with a low priority at software registration time may be serviced in a more rapid manner using the timeout mechanism. For example, usage of the interrupt reaffinitization results in more efficient hardware resource utilization among the plurality of processing cores. For example, usage of the interrupt reaffinitization allows better control of interrupt handling latency to a software programmer.

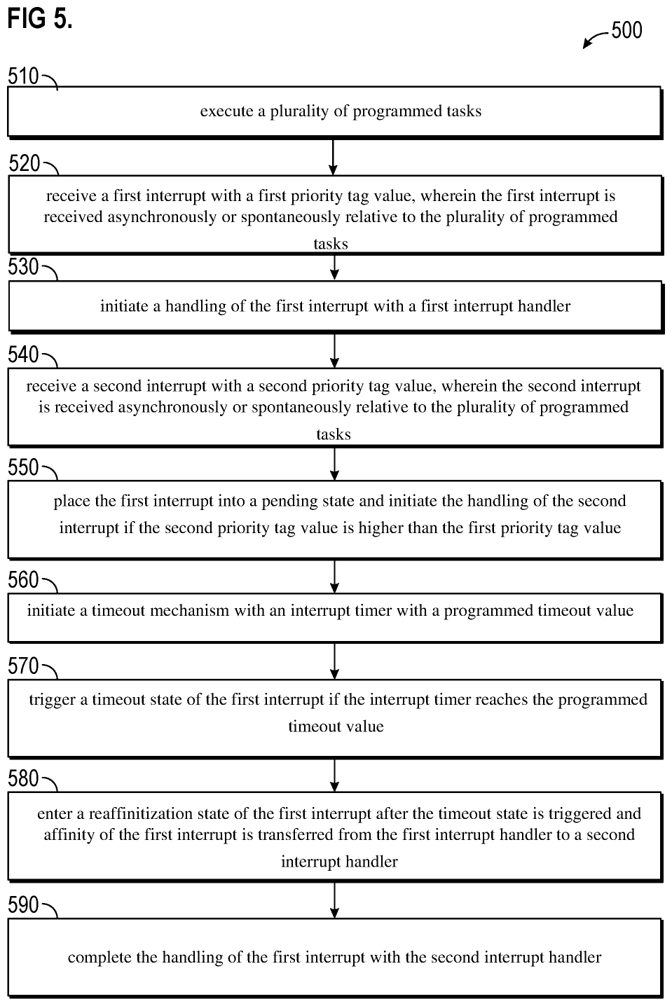

FIG. 5 illustrates an example flow diagram 500 for interrupt reaffinitization with a timeout mechanism. In block 510, execute a plurality of programmed tasks. In one example, the plurality of programmed tasks was executed. In one example, the execution is performed by a first processing engine. In one example, the plurality of programmed tasks may be managed by an operating system a priori to task execution. In one example, software may prescribe the sequencing of the plurality of programmed tasks.

In block 520, receive a first interrupt with a first priority tag value, wherein the first interrupt is received asynchronously or spontaneously relative to the plurality of programmed tasks. In one example, the first interrupt with the first priority tag value was received. In one example, the reception is performed by the first processing engine.

In block 530, initiate a handling of the first interrupt with a first interrupt handler. In one example, the handling of the first interrupt with the first interrupt handler was initiated. In one example, the first interrupt handler is part of the first processing engine.

In block 540, receive a second interrupt with a second priority tag value, wherein the second interrupt is received asynchronously or spontaneously relative to the plurality of programmed tasks. In one example, the second interrupt with the second priority tag value was received. In one example, the reception is performed by the first processing engine.

In block 550, place the first interrupt into a pending state and initiate the handling of the second interrupt if the second priority tag value is higher than the first priority tag value. In one example, the first interrupt into a pending state was placed and the handling of the second interrupt if the second priority tag value is higher than the first priority tag value was initiated. In one example, the second priority tag value higher than the first priority tag value means that the second priority tag value has a lower numeric value than the first priority tag value. In one example, the placement and handling is performed by the first interrupt handler.

In block 560, initiate a timeout mechanism with an interrupt timer with a programmed timeout value. In one example, the timeout mechanism was initiated. In one example, the interrupt timer is initialized to a value of zero. In one example, the timeout mechanism is executed by the first interrupt handler.

In block 570, trigger a timeout state of the first interrupt if the interrupt timer reaches the programmed timeout value. In one example, the timeout state of the first interrupt if the interrupt timer reaches the programmed timeout value was triggered. In one example, the timeout state includes deregistration of the pending interrupt from the first processing engine. In one example, the timeout state is triggered by the first interrupt handler.

In block 580, enter a reaffinitization state of the first interrupt after the timeout state is triggered and affinity of the first interrupt is transferred from the first interrupt handler to a second interrupt handler. In one example, the reaffinitization state of the first interrupt after the timeout state is triggered and affinity of the first interrupt is transferred from the first interrupt handler to a second interrupt handler are entered. In one example, the first interrupt handler is part of the first processing engine and the second interrupt handler is part of a second processing engine.

In block 590, complete handling of the first interrupt with the second interrupt handler. In one example, the handling of the first interrupt with the second interrupt handler is completed. That is, complete all execution tasks associated with the first interrupt. In one example, the second interrupt handler is part of the second processing engine.

In one aspect, one or more of the steps for providing interrupt handling in FIG. 5 may be executed by one or more processors which may include hardware, software, firmware, etc. The one or more processors, for example, may be used to execute software or firmware needed to perform the steps in the flow diagram of FIG. 5. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus for implementing interrupt handling comprising:
a first processing engine;
a second processing engine; and
a timeout monitoring block coupled to the first processing engine and the second processing engine, wherein the timeout monitoring block is configured to reaffinitize an interrupt affined to the first processing engine to the second processing engine.

2. The apparatus of claim 1, further comprising an interrupt timer configured to trigger a transition from a pending state to a timeout state of the interrupt.

3. The apparatus of claim 2, wherein the interrupt timer is a component of the timeout monitoring block.

4. The apparatus of claim 3, further comprising a distributor configured to control and to manage the first processing engine and the second processing engine.

5. The apparatus of claim 4, wherein the timeout monitoring block is coupled to the distributor via a data interface and a control interface.

6. The apparatus of claim 5, wherein the timeout monitoring block resides within the distributor.

7. The apparatus of claim 4, further comprising a first peripheral module coupled to the first processing engine, wherein the first peripheral module is configured to receive a first private peripheral interrupt (PPI) as a first type of interrupt trigger and a first local peripheral interrupt (LPI) as a second type of interrupt trigger.

8. The apparatus of claim 7, further comprising a second peripheral module coupled to the second processing engine, wherein the second peripheral module is configured to receive a second private peripheral interrupt (PPI) as a third type of interrupt trigger and a second local peripheral interrupt (LPI) as a fourth type of interrupt trigger.

9. The apparatus of claim 8, further comprising a first CPU interface configured to send a first software generated interrupt (SGI) generated by the first processing engine to the distributor.

10. The apparatus of claim 9, wherein the first software generated interrupt (SGI) is subsequently routed by the distributor within an information processing system.

11. The apparatus of claim 9, further comprising a second CPU interface configured to send a second software generated interrupt (SGI) generated by the second processing engine to the distributor.

12. The apparatus of claim 11, wherein the second software generated interrupt (SGI) is subsequently routed by the distributor within an information processing system.

13. A method for implementing interrupt handling comprising:
placing a first interrupt into a pending state;
initiating a handling of a second interrupt;
initiating a programmed timeout value;
triggering a timeout state of the first interrupt when an interrupt timer reaches the programmed timeout value; and
entering a reaffinitization state of the first interrupt after the timeout state is triggered.

14. The method of claim 13, wherein the first interrupt includes a first priority tag value, and the second interrupt includes a second priority tag value.

15. The method of claim 14, wherein the second priority tag value is higher than the first priority tag value.

16. The method of claim 15, further comprising initializing the interrupt timer to the programmed timeout value.

17. The method of claim 16, wherein the initializing the interrupt timer includes enabling a timeout mechanism.

18. The method of claim 16, further comprising reaffinitizing the first interrupt from a first interrupt handler to a second interrupt handler.

19. The method of claim 18, further comprising receiving the first interrupt asynchronously relative to a plurality of programmed tasks.

20. The method of claim 18, further comprising receiving the first interrupt spontaneously relative to a plurality of programmed tasks.

21. The method of claim 19, further comprising initiating a handling of the first interrupt with the first interrupt handler.

22. The method of claim 21, further comprising receiving the second interrupt asynchronously relative to the plurality of programmed tasks.

23. The method of claim 21, further comprising receiving the second interrupt spontaneously relative to the plurality of programmed tasks.

24. The method of claim 22, further comprising completing the handling of the first interrupt with the second interrupt handler.

25. The method of claim 24, further comprising executing the plurality of programmed tasks.

26. An apparatus for implementing interrupt handling, the apparatus comprising:
means for placing a first interrupt into a pending state;
means for initiating a handling of a second interrupt;
means for initiating a programmed timeout value;
means for triggering a timeout state of the first interrupt when an interrupt timer reaches a programmed timeout value; and
means for entering a reaffinitization state of the first interrupt after the timeout state is triggered.

27. The apparatus of claim 26, further comprising:
means for initializing an interrupt timer to the programmed timeout value;
means for reaffinitizing the first interrupt from a first interrupt handler to a second interrupt handler;
means for receiving the first interrupt asynchronously or spontaneously relative to a plurality of programmed tasks;
means for initiating a handling of the first interrupt with the first interrupt handler; and
means for receiving the second interrupt asynchronously or spontaneously relative to the plurality of programmed tasks.

28. A non-transitory computer-readable medium storing computer executable code, operable on a device comprising at least one processor and at least one memory coupled to the at least one processor, wherein the at least one processor is configured to implement interrupt handling, the computer executable code comprising:
instructions for causing a computer to place a first interrupt into a pending state;
instructions for causing the computer to initiate a handling of a second interrupt;
instructions for causing the computer to initiate a programmed timeout value;
instructions for causing the computer to trigger a timeout state of the first interrupt when an interrupt timer reaches a programmed timeout value; and
instructions for causing the computer to enter a reaffinitization state of the first interrupt after the timeout state is triggered.

29. The non-transitory computer-readable medium of claim 28, further comprising instructions for causing the computer to perform the following:
initialize an interrupt timer to the programmed timeout value;
reaffinitize the first interrupt from a first interrupt handler to a second interrupt handler;
receive the first interrupt asynchronously or spontaneously relative to a plurality of programmed tasks;
initiate a handling of the first interrupt with the first interrupt handler; and
receive the second interrupt asynchronously or spontaneously relative to the plurality of programmed tasks.
